(19) United States
(12) Patent Application Publication
(10) Pub. No.: US 2013/0197895 A1
(43) Pub. Date: Aug. 1, 2013

(54) REAL-TIME SERVER MANAGEMENT

(71) Applicants: Zhikui Wang, Fremont, CA (US); Alan L. Goodrum, Tomball, TX (US); Daniel Moran Galvan, (US)

(72) Inventors: Zhikui Wang, Fremont, CA (US); Alan L. Goodrum, Tomball, TX (US); Daniel Moran Galvan, (US)

(21) Appl. No.: 13/362,942

(22) Filed: Jan. 31, 2012

(51) Int. Cl. G06F 9/44

(52) U.S. Cl. 703/21

(57) ABSTRACT

A method for real-time server management may include determining a server architecture model based on performance characteristics of a component of a server. The method may further include determining a real-time model of the server from the server architecture model based on real-time server operation data, and adapting a performance controller for the server to operational characteristics of the server based on the real-time model.

### BACKGROUND

A server often includes internal performance controllers, such as, for example, a power efficiency controller, a power capping controller, and a fan controller. These performance controllers generally provide for manageability and operational efficiency of a server. Due to the heterogeneity of servers, tuning the internal performance controllers has been found to be challenging. For example, customers often customize servers, which results in different server capacity and performance. As another example, due to even small variations in server components, the efficiency of power supplied to the server and/or cooling efficiency of fans may differ in two servers that have identical specifications. Moreover, operational conditions of servers tend to vary over time, for example, due to changes in workload intensity or variations in ambient operating temperature conditions. Unless the performance controllers are adapted to configuration and operational heterogeneity of a server, the server power consumption may exceed a power cap threshold if an inaccurate model is used for the power cap estimation. Further, cooling air is often wasted if the fan controller does not adapt to server changes.

In order to address the foregoing aspects of server performance, performance controllers have been known to provide a server with sufficient margin (e.g., guard-band of the power cap) to accommodate varying configurations or operational condition changes. Further, the operation of performance controllers may be based on pre-defined scenarios. For example, operation of a fan controller may be based on mapping of fan speeds to server temperatures for different server and fan configurations. These approaches are either labor intensive or inaccurate, and often result in higher cost, non-optimized performance or even performance violations.

### BRIEF DESCRIPTION OF DRAWINGS

Features of the present disclosure are illustrated by way of example and not limited in the following figure(s), in which like numerals indicate like elements, in which:

FIG. 1 illustrates a high-level diagram for a real-time server management apparatus, according to an example of the present disclosure;

FIG. 2A illustrates a power efficiency graph for a power supply for changes in direct current (DC) output load and input line voltage, according to an example of the present disclosure;

FIG. 2B illustrates an example of a power loss graph for the power supply of FIG. 2A, for changes in DC output load and input line voltage, according to an example of the present disclosure;

FIG. 3A illustrates an example of operation of a power supply model for changes in power supply configuration, and further illustrates errors in the estimation of losses, according to an example of the present disclosure;

FIG. 3B illustrates an example of updating of values of model parameters for the power supply model of FIG. 3A, according to an example of the present disclosure;

FIG. 3C illustrates a comparison of three DC caps for a power capping controller for meeting a single alternating current (AC) cap for the power supply model of FIG. 3A, according to an example of the present disclosure;

FIG. 4A illustrates an example of a system power versus temperature graph for generating a power leakage model, according to an example of the present disclosure;

FIG. 4B illustrates an example of a leakage versus fan power graph for the power leakage model of FIG. 4A, according to an example of the present disclosure;

FIG. 5 illustrates a method for real-time server management, according to an example of the present disclosure; and

FIG. 6 illustrates a computer system, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

### 1. Overview

A server may include internal performance controllers for real-time performance management, such as, for example, a power efficiency controller, a power capping controller, a fan controller, etc. These controllers are to provide for manageability and operational efficiency of a server. For example, the power efficiency controller is to control server components to maximize the efficiency of power supplied to the server (i.e., the ratio of computational work per unit time to input power). The power capping controller may ensure that a server does not use more than the specified amount of power and cooling capacity assigned. For example, the power capping controller may use power monitoring and control mechanisms built into a server to limit, or cap, the power consumption of the server or a group of servers. Further, the fan controller may incrementally increase or decrease fan speed to account for changes in temperature within a server. Due to, for example, diversity in server configurations and time-varying operational conditions of servers, it can be challenging to tune the performance controllers to account for such diversity.

According to an example, a real-time server management apparatus is provided and is to implement real-time server model calibration and performance controller tuning. The apparatus may include an offline modeler module to determine a server architecture model based on offline analysis of the server components. The modules and other components of the apparatus may include machine readable instructions, hardware or a combination of machine readable instructions and hardware. The apparatus may further include a real-time modeler module to create a real-time model (e.g., a numerical model) of the server from the server architecture model based on real-time operation data. The apparatus may further include a performance optimization module that is to automatically tune the performance controllers based on the real-time model to optimize server performance and to adapt the performance controllers to operational conditions of the server based on the real-time model that may vary over time.

As described in detail below, examples of application of the real-time server management apparatus are described for a power supply and for processor power leakage. The examples demonstrate the feasibility of the real-time modeler module to adapt to variations in server configuration and operational conditions. Simulation based on the server architecture model and the real-time model of the server further demonstrate the capabilities of the real-time server management apparatus to automate configuration or tuning of the server performance controllers. For example, the simulation demonstrates the capabilities of the real-time server management apparatus to automate configuration of the power capping controller or to reduce server power consumption by tuning the configuration of the fan controller.

The server components disclosed herein may include, for example, a fan, a memory, a power supply, a processor, a peripheral component interconnect (PCI) bus, a disk etc. The component may also be the server itself. For example, the components may be other information technology (IT) equipment such as, for example, storage units and networking switches/routers etc. According to an example, the server architecture model is based on an offline analysis (i.e., without the server sending, receiving or processing time-varying data, as opposed to a real-time analysis, which would be based on a server sending, receiving or processing time-varying data) of the server component, and includes one of, for example, a linear, a polynomial, or an exponential function. The server architecture model may also be based on a physical or data-based analysis of a server component offline or in real-time. In addition, the real-time modeler module is to determine parameter values, or changes in the parameter values, of the server architecture model based on the real-time server operation data. The real-time modeler module may determine parameter values of the server architecture model through application of adaptive filters. The adaptive filters may be based, for example, on recursive least square (RLS) regression.

The server architecture model for the power capping controller may be based on power loss of a power supply as a function of the output power. As described in further detail below, power capping runs off of a fast analog output for the power supply that is proportional to the DC (output) load. Since a user cap is set in AC (input) power, for the capping hardware to know what DC load corresponds to which AC input, the output power is mapped to the input power. The mapping of the output power to the input power can be derived either from the efficiency of the power supply or the loss function of the power supply. With regard to the server architecture model for the fan controller, this model may account for leaked power, system power and fan power. The real-time operation data may represent central processing unit (CPU) utilization, server temperature, fan speed, or server power.

As described in detail below, a method for real-time server management may include determining a server architecture model based on performance characteristics of a component of a server. The method may further include determining a real-time model of the server from the server architecture model based on real-time server operation data, and adapting a performance controller for the server to operational characteristics of the server based on the real-time model.

For the method described herein, the method may further include automatically adapting the performance controller for the server to changes in operational characteristics of the server based on the real-time model. The method may include determining the server architecture model based on an offline analysis of the server component. The method may include determining parameter values of the server architecture model based on the real-time server operation data. The method may further include determining parameter values of the server architecture model by adaptive filters.

As described in detail below, a non-transitory computer readable medium may have stored thereon a computer executable program for real-time server management. The computer executable program, when executed, may cause a computer system to determine a server architecture model based on performance characteristics of a component of a server. The computer executable program may cause the computer system to determine a real-time model of the server from the server architecture model based on real-time server operation data, and adapt a performance controller for the server to operational characteristics of the server based on the real-time model.

The real-time server management apparatus disclosed herein provides automatic server performance optimization and adaptability to varying operational conditions. The apparatus thus provides self-management capabilities to a server. The apparatus provides for optimization of server energy efficiency, power consumption capping, and operational stability regardless of changes to operational conditions. Adaptability of a server to varying operational conditions may provide for reduction in engineering time for configuring a server for customers with different needs, and reduction in potential cost of a server. The apparatus also provides for scalable management by facilitating self-management of servers and exposing the real-time models to higher-level functions such as, for example, data center workload management.

### 2. Apparatus

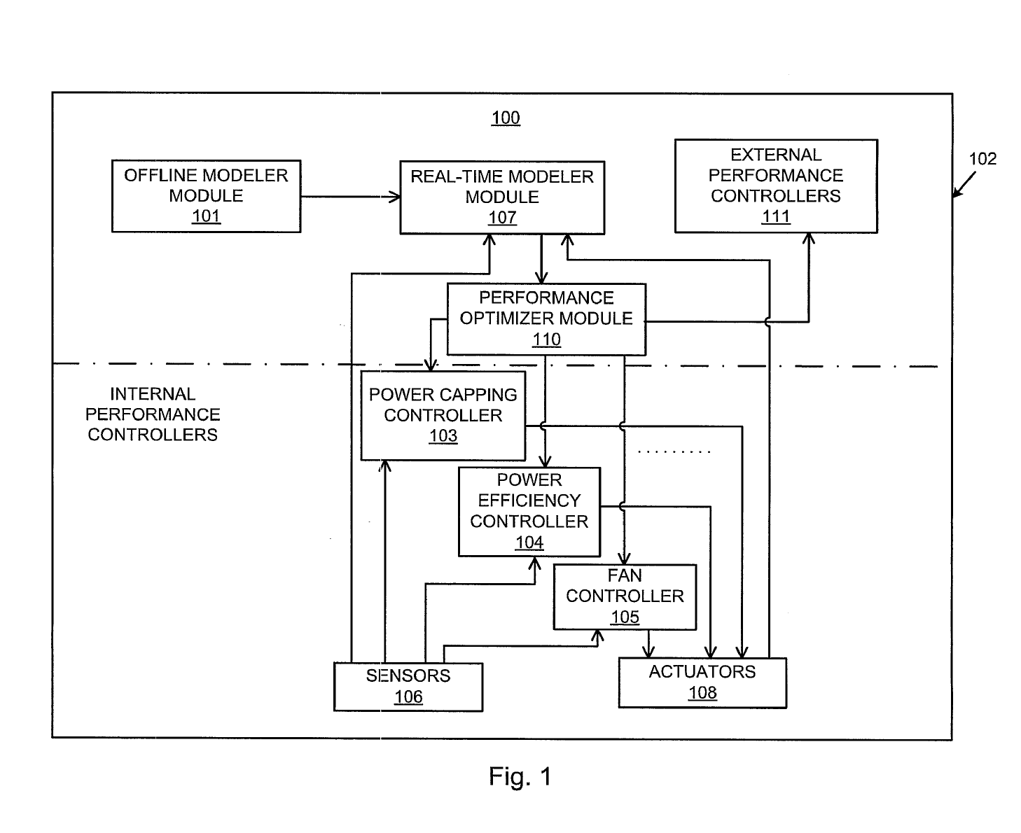

FIG. 1 illustrates a high-level diagram for a real-time server management apparatus 100, according to an example. Referring to FIG. 1, the apparatus 100 may include an offline modeler module 101 to determine a server architecture model based on offline analysis of components of a server 102. The offline modeler module 101 may also determine an architecture model for a set of servers that have common characteristics. The server components subject to offline analysis may include, for example, fans, memory, power supplies, processors (not shown), etc. As described in further detail below, the server 102 may include performance controllers such as, for example, a power capping controller 103, a power efficiency controller 104 and a fan controller 105. The server 102 may further include sensors 106 for sensing various server functions and for feeding the sensed signals to the performance controllers and a real-time modeler module 107. The performance controllers may feed into actuators 108 for actuating various functions of server components, such as, for example, fans, memory and processors. The apparatus 100 may be implemented within the framework of the server 102 as shown in FIG. 1, or some or all may be implemented as a separate apparatus from the server 102.

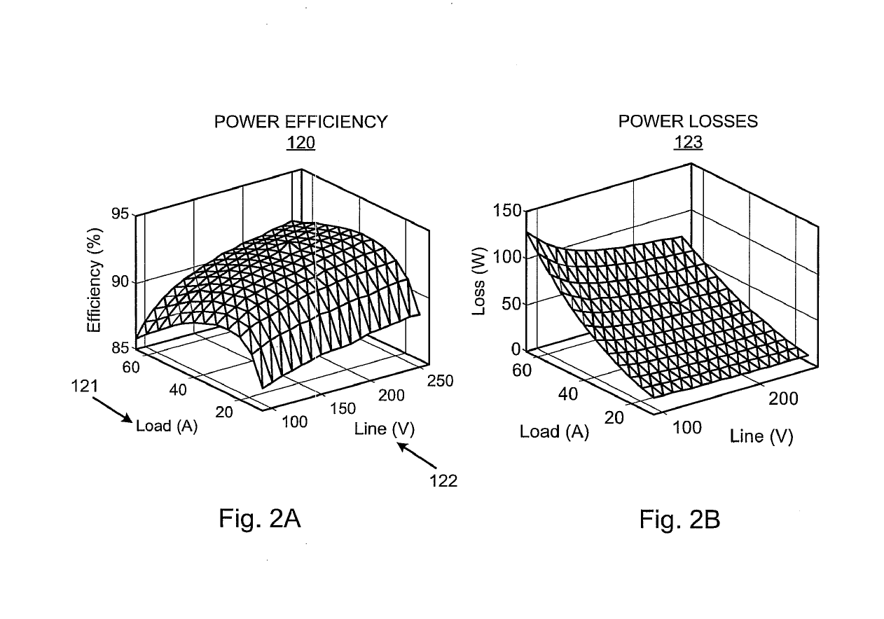

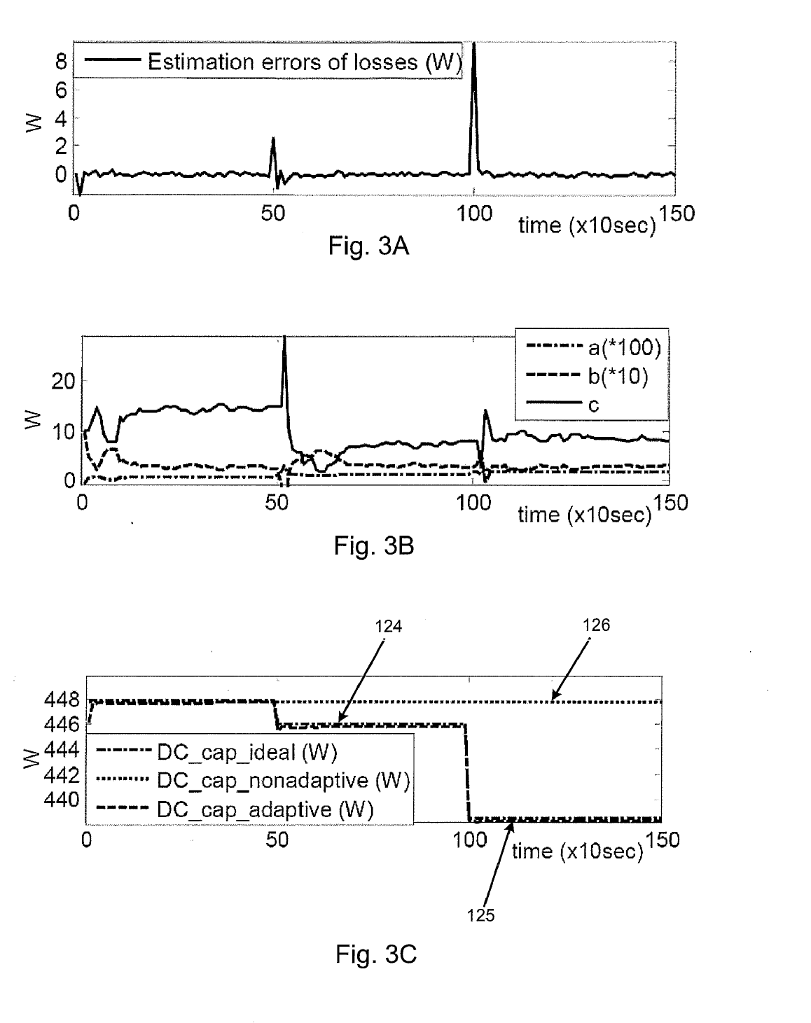

The server components may be modeled based on their performance characteristics. Models of server components may have different architectures (e.g., linear, polynomial, exponential functions, or other first-principle models based on physical and computing principles). These architectures may be chosen by the offline modeler module 101 through physical analysis of a server and offline experiments. For example, with regard to components such as power supplies, as described below with reference with FIGS. 2A-3C, benchmarking data for power supplies that have light, medium or heavy capacities and made by different vendors may be analyzed. As also described below, based on such analysis, a second-order polynomial function (i.e., a*Load²+b*Load+c) may provide a good fit to represent the power losses of the power supplies as functions of the load, with the coefficients (a, b, c) varying along with the power supply, the air temperature and the line voltage. Thus, based on such analysis, architectures for different components may be chosen by the offline modeler module 101 through physical analysis of a server and offline experiments.

Referring to FIG. 1, the real-time modeler module 107 is to create a real-time model (e.g., a numerical model) of the server 102 from the server architecture model based on real-time operation data. The real-time operation data may include, for example, central processing unit (CPU) utilization, server temperatures, fan speeds, server power, etc. This data may be captured and fed to the real-time modeler module 107. The data may describe a particular server configuration and operational conditions. The real-time modeler module 107 may determine varying parameter values for the server architecture model through use of adaptive filters. For example, the real-time modeler module 107 may determine varying parameter values through RLS regression. The varying parameter values may be due to the inherent heterogeneity of server components. The adaptive filters may be excited by dynamically varying signals, such as, for example, varying workloads. The real-time models may be categorized into various models, such as, for example, a power supply model, or a power leakage model. For example, a real-time model for power supplies may use server real-time AC inputs and DC outputs to build a server power supply efficiency model. For example, as described below with reference to FIGS. 2A-3C, server real-time AC inputs and DC outputs may be used to build a power supply model (i.e., a real-time model for power supply).

Once the parameter values are determined, a performance optimizer module 110 may reconfigure or adapt individual performance controllers based on the real-time models so that the performance controllers adapt to the changes in the server operational characteristics.

As discussed above, the server 102 may include performance controllers such as, for example, the power capping controller 103, the power efficiency controller 104 and the fan controller 105. The power capping controller 103, power efficiency controller 104 and fan controller 105 may be designated internal performance controllers. External performance controllers 111, such as, for example, a group-level power capping controller or a IT workload manager, may also be exposed with the real-time models and reconfigured or adapted accordingly.

With regard to the power capping controller 103, a user may provide power caps in units of AC input power. However, in this example, the power capping controller 103 operates on power supply DC output power. Therefore, choosing the proper target DC output power cap is dependent on the efficiency of the power supply. As the efficiency of the power supply changes over time, the performance optimizer module 110 may identify the changes and tune the DC output power cap accordingly.

For example, referring to FIGS. 2A-3C, an example of the real-time server management apparatus 100 implementation for controlling the power capping controller 103 is shown. The example is generally referred to herein as the power supply model.

With regard to the power supply model, the AC-DC efficiency of power supplies may vary along with the DC load. The AC-DC efficiency may also be affected by other factors, such as, for example, the power supply capacity, the vendor, the input line voltage, and the ambient air temperature. FIG. 2A shows an example of a power efficiency graph 120. The power efficiency graph 120 shows changes in DC load (A) at 121 and line voltage (V) at 122. The offline modeler module 101 may analyze benchmarking data, such as the power efficiency graph 120, for different power supplies for servers that have light, medium or heavy capacities, which are made by different vendors. Based on such analysis, the offline modeler module 101 may determine that a second-order polynomial (i.e., a*Load²+b*Load+c) may provide a good fit to represent power losses of supplies as a function of the load (i.e., output power), where coefficients (a, b, c) respectively are specific to the power supply. The second-order polynomial also captures the main losses, including power consumed by the internal fans. However, the coefficients (a, b, c) respectively vary along with the power supply, the air temperature and the line voltage, and are determined by the real-time modeler module 107 through RLS regression.

FIG. 2B shows an example of a power loss graph 123 for the power supply of FIG. 2A, for changes in DC load and line voltage. Thus, the power supply model may include a second-order polynomial (i.e., a*Load²+b*Load+c) as determined by the offline modeler module 101 for controlling the power capping controller 103, with the coefficients (a, b, c) being determined by the real-time modeler module 107. Based on the power supply model, the performance optimizer module 110 may reconfigure individual related performance controllers (i.e., the power capping controller 103) so that the performance controllers adapt to the changes in the server operational characteristics.

FIGS. 3A-3C show an example of the operation of the power supply model when the server configuration changes. The example is shown for a power supply model simulating a server including, for example, two processors and two power supplies sharing load equally, with the server running workloads that vary randomly between 0 and 100% utilization. FIG. 3A shows an example of the error in the estimation of the losses (W) that is produced by the power supply model. Referring to FIG. 3A, the spike in the error at time 50 represents how the power supply model reacts to one of the power supplies being pulled out, and the spike in the error at time 100 represents how the power supply model reacts to the line voltage (V) being reduced, for example, from 120V to 90V.

Referring to FIG. 3B, the values of the coefficients (a, b, c) as determined by the real-time modeler module 107 are shown for the same series of events as shown in FIG. 3A. It can also be seen that at times 50 and 100, the values of the coefficients (a, b, c) are automatically updated by the real-time modeler module 107 through RLS regression. For FIG. 3B, although there are transient periods before the parameters (i.e., coefficients (a, b, c)) converge, the estimation error converges within approximately one or two intervals to the noise level.

FIG. 3C shows a comparison of three DC caps for the power capping controller 103 to meet a single AC cap of 486W. For FIG. 3C, an ideal DC output power cap curve, that is, the DC output cap that is calculated using the exact power supply models, is shown at 124. The cap values should be tuned at the times 50 and 100 since the power supply efficiency changes at those times. The power cap curve that is estimated based on a fixed model is shown at 126. The power cap curve generated by the power supply model is shown at 125. Referring to FIG. 3C, between time 0-50, both the fixed model cap curve at 126 and the power supply model cap curve at 125 follow the ideal cap curve at 124. However, when the server configuration changes and the efficiency changes (i.e., at time 50 that represents one of the power supplies being pulled out and at time 100 that represents the line voltage (V) being reduced from 120V to 90V), the fixed model cap curve at 126 is over-estimated, while the power supply model cap curve at 125 driven by the performance optimizer module 110 closely follows the ideal cap curve at 124.

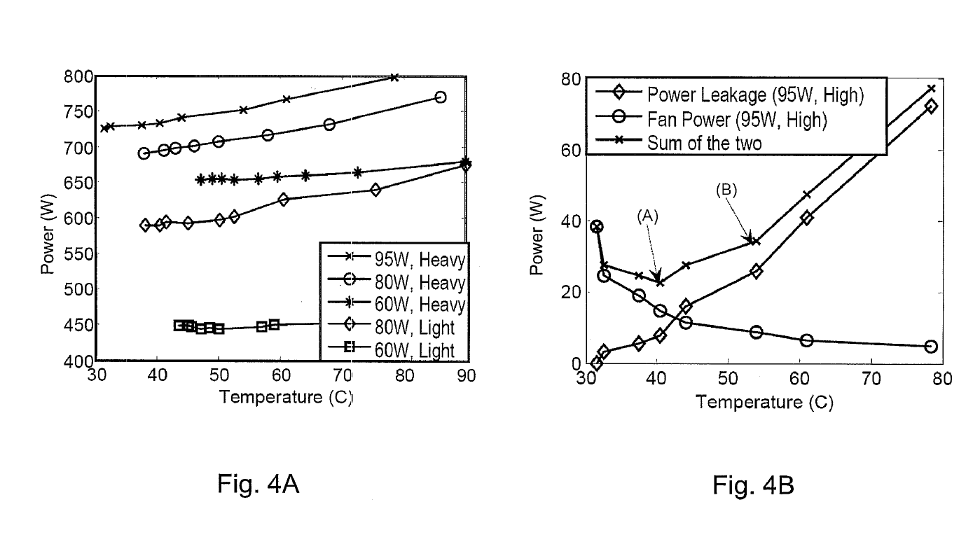

Referring to FIGS. 4A and 4B, an example of implementation of the real-time server management apparatus 100 for controlling the fan controller 105 is shown. The example is generally referred to herein as the power leakage model.

Power leakage is another factor that may contribute to the inefficiency of servers. Similar to the power supply model, the power leakage model of a server may be determined by the offline modeler module 101 as follows:

Powerₛₑᵣᵥₑᵣ=Power_{leaked}+Power_{system}+Power_{fans}=aₗ*T_{CPU}+aₛ*Util_{CPU}+Power_{fans}+P₀(*)

For the power leakage model, the server power may be determined as a summation of leaked power, system power and fan power. The system power in the power leakage model differs from the power (W) shown in FIG. 4A, which is the sum of the system power, the leaked power and P₀. The leaked power, system power and fan power may be respectively determined as a linear function of CPU temperature (T_{CPU}), CPU utilization (Util_{CPU}) and fan power consumption (Power_{fans}) of fan power models, with the coefficients (aₗ, aₛ, P₀) being determined by the real-time modeler module 107. The fan power may either be measured in real time, or may be characterized as a function of the fan speed (e.g., a cubic function of the fan speed) and then the coefficients of the cubic function may be identified in real-time. P₀ may also be determined in real-time. The CPU temperature, CPU utilization and fan power consumption of fan power models may be measured by the sensors 106 (see FIG. 1).

FIG. 4A shows an example of the server power (i.e., the AC power minus the fan power) versus temperature graph for determining values of the coefficients for the power leakage model. FIG. 4A shows the results of the total server power (minus the fan power) as functions of the CPU temperature for the server with five different configurations (i.e., 95W processor with 16-4G memory dual in-line memory modules (DIMMs) shown as “95W, Heavy” in FIG. 4A, 80W processor with 16 4G memory DIMMs (“80W, Heavy”), 60W processor with 16 4G memory DIMMs (“60W, Heavy”), 80W processor with 3 4G memory DIMMs (“80W, Light”) and 60W processor with 3 4G memory DIMMs (“60W, Light”)). The data points for each configuration may be collected when the fan speed is varied in steps from high to low values (so that the fan power (not shown in the figure) is decreased and the CPU temperature is increased) while the CPU utilization is almost zero, which means that the varying power is due to the leakage for each configuration. For FIG. 4A, it can be seen that the server power increases linearly along with the temperature due to leakage, while the slopes vary along with the five server configurations. The CPU power may be represented as a linear function of the CPU utilization. When the temperature and CPU utilization vary over time during operation and the fan power can be measured or estimated from fan speed using the fan power model, the coefficients (aₗ, aₛ, P₀) can then be determined by the real-time modeler module 107.

FIG. 4A shows that if fan speed is decreased (such that fan power decreases), CPU temperature increases and leaked power increases. However, if the fan speed is increased (and the fan power increases), the CPU temperature decreases and the leaked power decreases. In other words, there is a tradeoff between the fan power and the leaked power. FIG. 4B shows fan power consumption and the varying component of leakage (from the zero point when the temperature is approximately 30° C.) with fan speed varied for the server configuration with the 95W processor with 16 4G memory DIMMs (“95W Heavy” in FIG. 4A). The tradeoff between the fan power and the leakage shows that the optimal temperature is at approximately 40° C. (e.g. point (A)), when the sum of the fan power and the leaked power is the lowest, corresponding to approximately 30% of fan speed (not shown). An application of the power leakage model is described with reference to FIG. 4B.

An application of the power leakage model may include optimizing operation of the fan controller 105 by the performance optimizer module 110. A fan controller may vary the fan speed to maintain the server temperatures, e.g., that of the CPU, disk, memory or PCI bus, below some threshold upon changes such as, for example, those of the workload and the inlet air temperatures. The fan speed may also be lower bounded by the fan controller to maintain certain air flows traveling through the server. With the help of the leaked power models and other models such as CPU temperature models and fan power models, the performance optimizer may determine the optimal operation temperature of the server, e.g., that of the CPU, so that the sum of the fan power and leaked power can be minimized. The optimal operation temperature value may then be sent to the fan controller as the threshold, if it is lower than the default threshold of the fan controller. Another example of the performance optimizer using the leaked power model is to determine the minimum fan speed for the fan controller. For instance, according to FIG. 4B, the fan speed may be lower bounded at approximately 30% corresponding to location (A) for the fan controller 105 so that the total power is minimized when the server is idle. Compared, for example, to a fan speed of 20% that corresponds to location (B), approximately 12W of power is saved (when the server is idle) at location (A).

### 3. Method

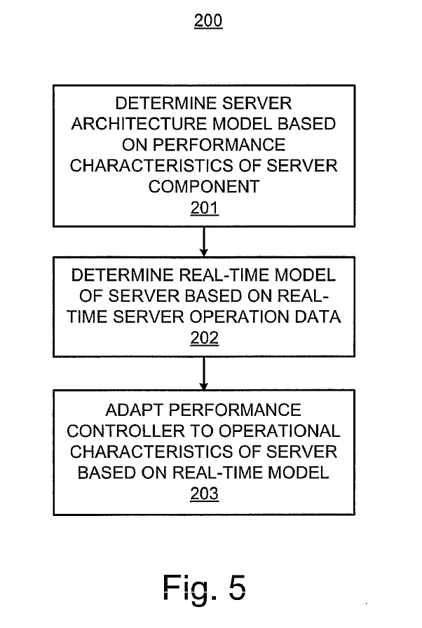

FIG. 5 illustrates a flowchart of a method 200 for real-time server management, according to an example. The method 200 may be implemented on the real-time server management apparatus described above with reference to FIGS. 1-4B by way of example and not limitation. The method 200 may be practiced in other apparatus.

Referring to FIG. 5, at block 201, the method may include determining a server architecture model based on performance characteristics of a component of a server. For example, referring to FIG. 1, the offline modeler module 101 may determine an architecture model for a set of servers that have common components of the server 102. The offline modeler module 101 may also determine an architecture model for a set of servers that have common characteristics. The server components subject to offline analysis may include, for example, fans, memory, power supplies, processors (not shown), the server itself etc. Models of server components may have different architectures (e.g., linear, polynomial, or exponential functions). These architectures may be chosen by the offline modeler module 101 through physical analysis of a server and/or data analysis from offline experiments.

At block 202, the method may include determining a real-time model of the server from the server architecture model based on real-time server operation data. For example, referring to FIG. 1, the real-time modeler module 107 may create a real-time model (e.g., a numerical model) of the server 102 from the server architecture model based on real-time operation data. The real-time operation data may include, for example, central processing unit (CPU) utilization, server temperatures, fan speeds, and server power. This data may be captured and fed to the real-time modeler module 107. The data may describe a particular server configuration and operational conditions. For the real-time model, the real-time modeler module 107 may determine varying parameter values for the server architecture model through adaptive filters. The varying parameter values may be due to the inherent heterogeneity of server components and/or varying operation conditions of the server. The adaptive filters may be excited by dynamically varying signals, such as, for example, varying workloads.

At block 203, the method may include adapting a performance controller for the server to operational characteristics of the server based on the real-time model. For example, referring to FIG. 1, the performance optimizer module 110 may reconfigure or adapt individual performance controllers based on the real-time models so that the performance controllers adapt to the changes in the server operational characteristics. As discussed above, the server 102 may include performance controllers such as, for example, the power capping controller 103, the power efficiency controller 104 and the fan controller 105. The performance controller for the server may also automatically adapt to changes in operational characteristics of the server based on the real-time model to thereby provide self-management capabilities to the server 102.

### 4. Computer Readable Medium

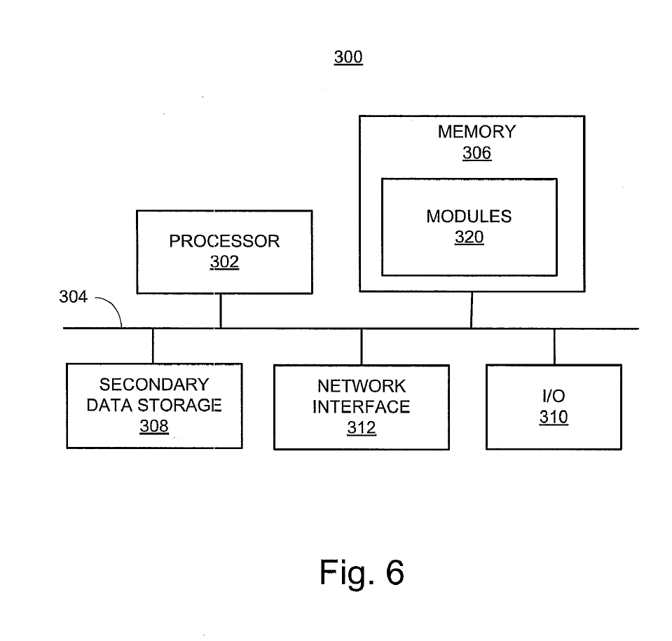

FIG. 6 shows a computer system 300 that may be used with the examples described herein. The computer system 300 represents a generic platform that includes components that may be in a server or another computer system. The computer system 300 may be used as a platform for the apparatus 100. The computer system 300 may execute, by a processor or other hardware processing circuit, the methods, functions and other processes described herein. These methods, functions and other processes may be embodied as machine readable instructions stored on computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 300 includes a processor 302 that may implement or execute machine readable instructions performing some or all of the methods, functions and other processes described herein. Commands and data from the processor 302 are communicated over a communication bus 304. The computer system 300 also includes a main memory 306, such as a random access memory (RAM), where the machine readable instructions and data for the processor 302 may reside during runtime, and a secondary data storage 308, which may be non-volatile and stores machine readable instructions and data. The memory and data storage are examples of computer readable mediums. The memory 306 may include modules 320 including machine readable instructions residing in the memory 306 during runtime and executed by the processor 302. The modules 320 may include the modules 101, 107 and 110 of the apparatus 100 shown in FIG. 1.

The computer system 300 may include an I/O device 310, such as a keyboard, a mouse, a display, etc. The computer system 300 may include a network interface 312 for connecting to a network. Other known electronic components may be added or substituted in the computer system 300.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for real-time server management, the method comprising:
determining a server architecture model based on performance characteristics of a component of a server;
determining, by a processor, a real-time model of the server from the server architecture model based on real-time server operation data; and
adapting a performance controller for the server to operational characteristics of the server based on the real-time model.

2. The method of claim 1, further comprising automatically adapting the performance controller for the server to changes in operational characteristics of the server based on the real-time model.

3. The method of claim 1, wherein the server architecture model is based on a physical or data-based analysis of the server component offline or in real-time.

4. The method of claim 1, wherein the server architecture model includes one of a linear, a polynomial, and an exponential function.

5. The method of claim 1, further comprising determining parameter values of the server architecture model based on the real-time server operation data.

6. The method of claim 1, further comprising determining parameter values of the server architecture model through use of adaptive filters.

7. The method of claim 6, wherein the adaptive filters are based on recursive least square (RLS) regression.

8. The method of claim 1, wherein the performance controller includes one of a power capping controller, and a fan controller.

9. The method of claim 1, wherein the performance controller includes a power capping controller, and wherein the server architecture model for the power capping controller is based on power loss of a power supply as a function of output power.

10. The method of claim 1, wherein the performance controller includes a fan controller, and wherein the server architecture model for the fan controller accounts for leaked power, system power and fan power.

11. The method of claim 1, wherein the real-time operation data represents one of power supply AC inputs, power supply DC outputs, central processing unit (CPU) utilization, server temperature, fan speed, and server power.

12. A real-time server management apparatus comprising:
a memory storing a module comprising machine readable instructions to:
determine a real-time model of a server from a server architecture model, wherein the real-time model is based on real-time server operation data and the server architecture model is based on performance characteristics of a component of the server; and
adapt a performance controller for the server to operational characteristics of the server based on the real-time model; and
a processor to implement the module.

13. The apparatus of claim 12, wherein the server architecture model is based on a physical or data-based analysis of the server component offline or in real-time.

14. The apparatus of claim 12, wherein the real-time operation data represents one of power supply AC inputs, power supply DC outputs, central processing unit (CPU) utilization, server temperature, fan speed, and server power.

15. A non-transitory computer readable medium having stored thereon a computer executable program for real-time server management, the computer executable program when executed causes a computer system to:
determine a real-time model of a server from a server architecture model, wherein the real-time model is based on real-time server operation data and the server architecture model is based on performance characteristics of a component of the server; and
adapt a performance controller for the server to operational characteristics of the server based on the real-time model.
